(19) United States
(12) Patent Application Publication
(10) Pub. No.: US 2006/0086871 A1
(43) Pub. Date: Apr. 27, 2006

(54) Adjustable tripod mechanism to support devices or transducers for scientific measurement

(75) Inventors: Antony Joseph, Goa (IN); Suryakant Tengali, Goa (IN); Rajachandran Madhan, Goa (IN); Ramchandra Gopal Prabhudesai, Goa (IN); Vijay Kumar, Goa (IN); Mathew Dias, Goa (IN); Shivanand Prabhudesai, Goa (IN)

Correspondence Address: NIXON & VANDERHYE, PC, 901 NORTH GLEBE ROAD, 11TH FLOOR, ARLINGTON, VA, 22203, US

(73) Assignee: Council of Scientific and Industrial Research, New Delhi (IN)

(21) Appl. No.: 10/974,011

(22) Filed: Oct. 27, 2004

(51) Int. Cl. F16M 11/02

(52) U.S. Cl. 248/178.1; 248/188.7

(57) ABSTRACT

The present invention relates to an adjustable tripod mechanism to support devices/transducers for scientific measurements such as weather station, radio transceiver, acoustic modem, and the like. More particularly, this invention relates to a novel, fully mechanical, and hand-operated tripod stand that incorporates (1) capability for rigidly mounting devices such as instruments, transducers, and so forth on a desired plane at a desired height for measurement of a multiplicity of parameters (e.g., meteorological parameters such as wind speed and direction, solar radiation, air temperature, barometric pressure, humidity, and the like); (2) rotation of any attached/mounted-device/transducer in the azimuthal direction at any angular intervals to facilitate orienting a mounted device in a given direction without the need for rotation of the legs of the tripod; (3) capability for partitioning of the tripod into a multiplicity of desirable smaller segments, thereby enabling its trouble-free transportation to remote areas; (4) trouble-free coupling of a plurality of separate members to achieve the desired height for the tripod stand to suit a given installation environment; (5) improvement in the efficiency of assembly, de-assembly, and packing of the tripod system by rendering its members compact and dismountable; (6) achieving elegance in appearance and ease in mounting; (7) improvement in mechanical stability as a result of an adjustably wider base area; and (8) facility for locking the tripod mechanism to the floor to prevent its translational/angular movement under drag force induced by the prevailing wind.

### FIELD OF THE INVENTION

The present invention relates to an adjustable tripod mechanism to support devices/transducers for scientific measurement such as weather station, radio transceiver, acoustic modem, and the like. More particularly, this invention relates to a novel, fully mechanical, and hand-operated tripod stand that incorporates (1) capability for rigidly mounting devices such as instruments, transducers, and so forth on a desired plane at a desired height for measurement of a multiplicity of parameters (e.g., meteorological parameters such as wind speed and direction, solar radiation, air temperature, barometric pressure, humidity, and the like); (2) rotation of any attached/mounted-device/transducer in the azimuthal direction at any angular intervals to facilitate orienting a mounted device in a given direction without the need for rotation of the legs of the tripod; (3) capability for partitioning of the tripod into a multiplicity of desirable smaller segments, thereby enabling its trouble-free transportation to remote areas; (4) trouble-free coupling of a plurality of separate members to achieve the desired height for the tripod stand to suit a given installation environment; (5) improvement in the efficiency of assembly, de-assembly, and packing of the tripod system by rendering its members compact and dismountable; (6) achieving elegance in appearance and ease in mounting; (7) improvement in mechanical stability as a result of an adjustably wider base area; and (8) facility for locking the tripod mechanism to the floor to prevent its translational/angular movement under drag force induced by the prevailing wind.

### BACKGROUND OF THE INVENTION

Many devices such as (i) meteorological instruments used for measurement of parameters such as barometric pressure, wind speed and direction, air temperature, humidity, rain fall rate, and the like, that are needed for meteorological and oceanographic studies; (ii) anemometer that is needed for estimation of wind energy for a variety of applications (e.g., feasibility study prior to the establishment of wind-mill farm for generation of electricity from wind energy); (iii) pyranometer used for measurement of solar radiation and heat budget calculation; (iv) radio transceivers for transmission/reception of data; and (v) several other instruments/transducers are required to be mounted on a given plane at some desired height from the ground. In some situations (such as measurements made at Meteorological Offices, Merchant ships, Research Vessels and the like) these measuring devices are permanently mounted on purpose-built structures. However, in many other situations these measurements need to be made from a multiplicity of remote regions such as seacoasts, gulfs, hilly regions, and so forth for differing time-periods ranging from a few months to a year or more, and sometimes covering many seasons. In such situations the preferred mode for mounting the measuring instruments/devices/transducers is some kind of a tripod mechanism, primarily because of its ability for being folded as well as the ease of deployment.

Hitherto known tripod mechanism [K. Gibran (1980), “Tripod”, U.S. Pat. No. 4,215,839] describes a folding and adjustable tripod for supporting a camera or other apparatus. This device comprises of a central column having slots extending longitudinally of the column in which the upper end of the tripod legs are slidable. The legs are of fixed length and each include a slot along a portion of the length within which one end of an arm is slidably adjustable, the other end of the arm being pivotably attached to the lower portion of the column. The legs are extensible by sliding within the column slots while the angular extent of the legs is adjustable by slidable adjustment of the interconnecting arms. An advantage of this tripod is that it is suitable for support of a camera or other apparatus of a similar nature. However, the limitations of this tripod are that its legs are of fixed length and the interconnecting arms are of limited length. These limitations render the base area to be limited, thereby resulting in a reduced mechanical stability of the tripod under wind forcing and adverse meteorological conditions when such a tripod is to be used for mounting of transducers/instruments for measurements of meteorological parameters.

Another system, [P. Posso (1982), “Tripod with adjustable support surface for supporting various objects”, U.S. Pat. No. 4,309,010 assigned to Gefitec S. A] describes a tripod wherein its stand comprises a central support provided with pivot pins. The legs are telescopic and adapted to pivot in radial planes. The said tripod is useful for supporting photographic/cinematographic apparatus, projection apparatus, geodetic measuring instruments, antennas (for transmitting or receiving electromagnetic waves), or the like. An advantage claimed for this system is that all the parts are under compressive stress and, therefore, may be made of plastic material, thereby providing benefits such as ease of mass production, lightness, and the like. Whilst lightness provided by the use of plastic material is an advantage for tripods meant for supporting photographic and such other apparatus that are often carried by the human personnel, the said advantage may prove to be a disadvantage when the said tripod is to be used for supporting practically unattended autonomous instruments [e.g., meteorological instruments] that are deployed in the open environments for long periods. In such applications, the plastic materials are prone to become brittle with age under exposure to the heat and light from the sun, and the lightness of the tripod might render it unstable under external forces such as wind and turbulence. Another disadvantage of this tripod is that it permits only two levels of inclination of its legs with respect to the vertical, namely, ‘small’ inclination in one case and ‘considerable’ inclination in the other.

An alternate system, [P. C. Mooney (1986), “Locking mechanism for tripod and spreader legs”, U.S. Pat. No. 4,570,886] describes a tripod having three legs and a spreader having wheels at the bottom portion of the legs, and an interlocking mechanism for securing each of the said tripod legs to a respective spreader leg. An advantage of this tripod system is that it is provided with a mechanism to restrain the legs to prevent them from sliding outwardly. However, a limitation of this device is that it requires the use of three spreader legs and the attendant interlocking members, thereby increasing the number of mechanical members in the tripod. Further, whilst having wheels at the bottom portion of the legs is an advantage for a tripod meant for supporting a film or television camera, it is a disadvantage for a tripod meant for supporting instruments that are required to be rigidly and firmly fixed in space.

Another system, [B. A. Hartman, M. R. Kardack, and R. E. Ammendolia (1988), “Tripods”, U.S. Pat. No. 4,767,090 {assigned to Kar-Hart Productions, Inc. (Everett, Wash.}] describes a simple tripod for mounting instruments such as camera, telescope, and laser-based measuring devices such as those employed by surveyors. This tripod features a head (which is a single piece of material) and pivotable legs with a one-piece foot and a side-by-side or triangular array of hollow posts. An advantage of this arrangement is that it provides strength and rigidity at a low weight. The tripod components are fabricated principally from colorfast, impact resistant, synthetic polymers that are dimensionally stable under varying ambient temperatures, impact resistant, and also resistant to chemical attack and ultraviolet degradation. The synthetic polymer based components are said to be self-lubricating in situations of relative motion between them. Stability is promoted by rolling bearings that are located at the upper ends of the tripod legs. A cam-operated clamping mechanism is employed to lock the tripod leg assemblies together in the desired relationships. Either spike or tilting shoes are used to stabilize the tripod legs on the tripod-supporting stratum. An advantage of this tripod is that the tension between each leg and the head of the tripod is independently adjustable. However, while the device is useful for survey applications, the legs are not designed to mate intimately to the floor and also lack sturdiness that is required to support field-deployable instrument-ation for a substantially long period.

A still further system [Y. Hoshino (1991), “Adjustably Tiltable Tripod Stand”, U.S. Pat. No. 5,062,606 {assigned to Hoshino Gakki Co. Ltd. (JP)] describe a tripod stand for supporting a musical instrument or other object, wherein a main post is provided with an upper slide member to which the upper ends of the three legs of the tripod are connected by hinge means. An arm connects each leg with the lower portion of the main post. The movement of the slide member up and down causes selective inward and outward movement of the legs. One of the arms is adjustable in length and is typically adjusted longer than the other nonadjustable arms when it is desired to tilt the stand. The above-mentioned adjustability in length is obtained by making the arm telescopable in length or by providing the arm with a slidable and elongate slot that can be positioned at a desired length. An advantage of this tripod system is that it provides greater stability by increasing the angle between their legs and forming the lower ends of the legs into a triangle that supports the tripod stand. However, a limitation of this device is that it has a main post in addition to the three legs, and there are no means provided for mounting measuring instruments, transducers, and the like in a given plane. Another limitation of this device is the limited base area and, therefore, limited stability provided by the limited slant length of its legs in contrast to the larger height of its main post.

An yet another system [R. L. May (1991), “Adjustable Tripod Stand”, U.S. Pat. No. 5,072,910] describe a tripod stand comprising a longitudinal extensible upright portion, a plurality of collar members, and a plurality of movable leg members. An advantage of this device is that it allows independent positioning of its legs thereby allowing the longitudinal axis of the stand to be tilted to an off-vertical axis position for locating the center of gravity of the supported vehicle within the supporting legs. However, a limitation of this device is the limited base area and, therefore, limited stability provided by the limited slant length of its legs in contrast to the larger height of its main post.

Another system [J. E. Burns (1992), “Tripod”, U.S. Pat. No. 5,137,236] describes a tripod that is especially suited for use by a court reporter for supporting a court reporter's stenographic machine. The said tripod provides an adjustable support leg that allows the stenographic machine to be firmly and stably supported in space at different locations relative to the court reporter for increased comfort and change of position by the court reporter throughout the day. In this tripod, the leg includes an adjustable block and pin arrangement that provides several different positions relative to the supporting brace of that leg. The said mechanism allows change in inclination of the overall support device. A desirable feature of this device is that it is compact and small in size, and might suit well for the job for which it is intended. However, a limitation of this device is that it is not designed for being mounted on uneven terrains such as those observed in the open land and is not stable enough for withstanding large drag force induced by wind force that might be prevalent in an open environment.

Yet another system [K. Gibran and C. E. Casagrande (1993), “Tripod Having Collapsible Leg Assemblies and Extendible Neck and Latch Mechanisms for Maintaining Leg Assemblies and Neck in Predetermined Positions”, U.S. Pat. No. 5,222,705 {assigned to K. Gibran}] describes a collapsible and adjustable tripod stand for support of a camera or other apparatus. The said tripod comprises a central column having three sides, each side having a channel that is longitudinally formed. The leg comprises a leg member and a brace that can unfold to support the tripod and collapse to a closed position within the channel in each side of the central column. A neck telescopically extends from the top of the central column. A latch mechanism allows the neck to be lockable in a series of positions above the top of the column. The camera or other apparatus is screwed onto the support section. An advantage of this device is that it is simple in construction so that it can be used to support a small device such as a camera. However, a limitation of this device is the limited base area and, therefore, limited stability provided by the limited slant length of its legs in contrast to the larger height of its main post. Another limitation of this device is that it is not designed for being mounted on uneven terrains such as those observed in the open land and is not stable enough for withstanding large drag force induced by wind force that might be prevalent in an open environment.

Yet another system [G. Vinghog and A. Hagen (1994), “Tripod for Firearms”, U.S. Pat. No. 5,354,024 {assigned to Vinghogs Mek. Versted As (Duken, NO)}] describes a tripod for firearms comprising a pivot support disposed about a vertical axis and including three telescoping and adjustable legs, having resting points and being secured to flanges and three openings, and a fourth leg having a substantially shorter length than the other three legs. One of the legs is rotatable in a vertical plane. The other two legs are adapted to be at an acute angle to each other to insure support when firing at ground level in a direction substantially in a vertical plane through the longitudinal axis of the first leg. The fourth leg is connected to the first leg such that the former can be moved downward to create a support point substantially nearer the vertical rotation axis of the pivot support than the resting points of the other legs. An advantage with this tripod is that it provides adequate support to handle the recoil forces in the opposite direction during firing shots on targets in the air and also during directional firing at the ground level. While this tripod is useful in military applications, this is not designed for instrument/transducer mounting applications.

A further system [W. Sassmannshausen, K. H. Menzel, and A. Kleindienst (1996), “Stand”, U.S. Pat. No. 5,509,629 {assigned to Sonor Johs. Link Gmbh (Bad Berleburg, Del.)}] describes a tripod stand for receiving and holding objects, particularly musical instruments and/or accessories. This mounting device includes a center shaft and adjustable legs that are slidably mounted on the center shaft, wherein at least one of the legs can be swung about the center shaft. The legs are connected to sleeves that are arranged at the bottom and top ends of the said central shaft. A desirable feature of this device is the concentric arrangement of the sleeve members, thereby making it possible to adjust the inclination of the legs relative to the central shaft and to swing the swingable leg about the center shaft by loosening merely one tightening screw. While this type of a light and compact tripod stand is desirable for use in connection with musical concerts and operas, the device is not suitable for instrument/transducer mounting applications in the open areas where the drag force acting on the mounting device as well as the mounted device can be significant during certain periods/seasons during which the need for measurements are most vital.

### OBJECTS OF THE INVENTION

The main object of the present invention is to provide a mechanical mounting device for rigidly and sturdily supporting any field-operated device such as a instrument (e.g., meteorological instrument), transducer, transceiver, and the like on a desired level plane.

Another object of the present invention is to provide a mechanical support device whose legs are operative to be folded together when not in use, and operative to be opened to an intended angular extent and to an intended vertical extent when under use.

Yet another object of the present invention is to provide adjustably large base area, thereby resulting in an improved mechanical stability of the tripod under wind forcing and adverse meteorological conditions, thereby enabling it to withstand large drag force induced by wind force that might be prevalent in an open environment.

A still another object of the present invention is to provide a support device that allows its erection in limited and/or confined areas such as a small stall (e.g., at a science/technology exhibition ground), or on uneven/multilevel surfaces such as open space with an uneven terrain.

A further object of the present invention is to provide a support mechanism having independently adjustable telescoping tubular legs for providing enhanced stability and for enabling easy adjustment of its height; and leveling of its instrument/transducer mounting platform in a desired plane.

A still further object of the present invention is to provide a support device that provides ease in erection by desirably tilting each of its legs independently.

Another object of the present invention is to provide capability for adjusting the mounting-platform of the tripod in a horizontal plane with the use of three threaded bolts and a spirit level that is integrated with the top planar platform member of the tripod so that the mounted device can be maintained in a horizontal plane.

Yet another object of the present invention is to facilitate trouble-free transportation of the support mechanism from any region including remote areas, by providing a means for its partition into a multiplicity of desirable smaller segments.

Still another object of the present invention is to facilitate easy coupling of a plurality of separate members of the legs of the support mechanism to achieve the desired height and base area to suit a given installation environment.

A further object of the present invention is to improve the efficiency of assembly, de-assembly, and packing of the support mechanism by rendering its members to be compact and dismountable.

Another object of the present invention is to facilitate trouble-free handling of the support mechanism during assembly, de-assembly, and packing by providing a cylindrical shape to its leg member segments.

A further object of the present invention is to provide a simple and miniature mechanism to select the desired angular extent of each leg in relation to the major axis of the tripod and to lock the tripod leg assemblies together in the desired relationships, thereby inhibiting the use of the conventionally employed rather long connecting rods/spikes to stabilize the tripod legs on the floor.

A still further object of the present invention is to provide a simple mechanism wherein its legs are restrained from sliding outwardly, with the use of compact interlocking members thereby avoiding the use of large base-rods, spikes, or spreader legs that are often conventionally used to stabilize the legs of the tripod.

Another object of the present invention is to facilitate quick assembly and de-assembly, which is an issue of paramount importance in periodic survey operations in numerous remote areas.

Other objects of the invention will become apparent from the following description.

### SUMMARY OF THE INVENTION

The present invention provides for an adjustable tripod mechanism to support devices/transducers for scientific measurements which provides for:
1. a novel, fully mechanical, and hand-operated tripod mechanism for rigidly mounting any device such as a measuring instrument (e.g., meteorological instrument), transducer, radio transceiver, acoustic modem and the like on a desired height and plane.
2. a mechanical support device whose legs are operative to be folded together when not in use, and operative to be opened to an intended angular extent and to an intended vertical extent when under use.
3. a mechanical support device that allows its erection in limited and/or confined areas or on uneven/multilevel surfaces such as open terrain.
4. a mechanical support device that provides for selective and independent positioning of the supported measuring instrument, device/transducer, radio transceiver, acoustic modem and the like on a desired height and plane.
5. improvement in stability as a result of a wider base area provided by its slidably and angularly adjustable variable-length leg members having wide foot area.
6. capability for trouble-free transportation (e.g., in the dicky of a car/van) from any region including remote areas, by partitioning the support mechanism into a multiplicity of desirable smaller members/segments.
7. easy coupling of a plurality of the separate members/segments of its legs to achieve the desired height to suit a given installation environment.
8. improving the efficiency of assembly, de-assembly, and packing by rendering its members to be compact and dismountable.
9. capability for trouble-free handling during assembly, de-assembly, and packing by providing a cylindrical shape to its leg members.
10. capability for adjusting the mounting-platform (for the mounted device) of the tripod in a horizontal plane with the use of three threaded bolts and a spirit level that is integrated with the top platform of the tripod so that the mounted device can be maintained in a horizontal plane.
11. capability for significantly minimizing the formation of wakes in the vicinity of the mounted instrument/transducer package during large wind forcing.
12. providing elegance in appearance and ease in mounting.
13. facilitating quick assembly and de-assembly, which is an issue of paramount importance in periodic survey operations in numerous remote areas.

Accordingly, the present invention provides an adjustable tripod mechanism to support devices/transducers for scientific measurements, whose legs are operative to be folded together when not in use, and operative to be opened to an intended angular extent and to an intended vertical extent when under use; which consists primarily of a planar plate member [10] for mounting any device such as an instrument, transducer, and the like; another planar plate member [11] attached to the said planar plate member [10] wherein the said planar plate member [11] is integrally joined to at least three pairs of coupling female members [13] to each of which a mating male coupling member [14] are loosely joined; an adjustable tripod mechanism to support devices/transducers for scientific measurements, wherein the coupling members [14] are integrally joined to tubular leg members [15], which are further loosely and telescopically attached to inner tubular leg members [16], the said leg member [16] being attached to another tubular leg member [17], whose bottom end is pivotably coupled to base plate member [18]; an adjustable tripod mechanism to support devices/transducers for scientific measurements, wherein a spirit level [19] is integrally joined to the top planar plate member [10] for the purpose of leveling the said plate member [10] to a horizontal plane; an adjustable tripod mechanism to support devices/transducers for scientific measurements, wherein each of the said leg members comprising of leg segment members [15], [16], [17], and base plate member [18] are adapted to pivot in radial planes along the planar slot [20] provided on the female coupling member [13]; an adjustable tripod mechanism to support devices/transducers for scientific measurements, wherein the slots [21] provided on the top planar plate member [10] enables mounting of devices, transducers, transceivers and the like; an adjustable tripod mechanism to support devices/transducers for scientific measurements, wherein the planar plate member [11] is attached to the planar plate member [10] with the use of at least three preferably, although not necessarily, equally spaced threaded support members [12], wherein the said threaded support members [12] are positioned in notches [22] drilled on the upper planar surface of the circular plate member [10], wherein the bottom portion of the said support members [12], which freely rests on the top surface of the planar plate member [11], cooperates with the interior threaded surface of the nut members [23] to ensure the guiding of the said support members [12] in rotation thereby facilitating fine upward/downward movement of the top planar plate member [10] through the desired spatial separation relative to the planar plate member [11]; an adjustable tripod mechanism to support devices/transducers for scientific measurements, wherein the nut member [23] is integrally joined to the planar plate member [10] to facilitate its fine movement in upward/downward direction; an adjustable tripod mechanism to support devices/transducers for scientific measurements, wherein the tubular member [41], which is integrally joined to the planar plate member [10], has an integral step in the form of an exterior collar [42] so that the separation between the plate members [10] and [11] can remain flexible to a certain distance to allow fine tuning of the height of the plate member [10] by manually turning the nut member [46], which is an integral part of the bolt member [12].; an adjustable tripod mechanism to support devices/transducers for scientific measurements, wherein the tubular member [41] extends downward through a central axial perforation drilled perpendicularly on the planar surface of the plate member [11] so that the planar plate member [10] together with the mounted device/transducer can be rotated in any desired azimuthal direction; an adjustable tripod mechanism to support devices/transducers for scientific measurements, wherein the tubular member [41] can be fixed in the desired position with the use of a washer member [43], nut member [44] and locked in position with the use of a lock-nut member [45], thereby enabling the mounted device/transducer to be rigidly fixed in any desired azimuthal orientation; an adjustable tripod mechanism to support devices/transducers for scientific measurements, wherein each pair of the female coupling members [13] and its mating male coupling members [14] is pivotably coupled to each other through a threaded bolt member [24] so that the corresponding segment members [15], [16], [17] together with the base plate member [18] of each leg of the tripod are free to swing about the bolt member [24], thereby the said bolt member [24] operates as a hinge mechanism that allows folding the respective leg member along the axial plane of the coupling member [13] and [14] of each leg, thereby enabling the pivoting of the legs to be controlled; an adjustable tripod mechanism to support devices/transducers for scientific measurements, wherein the said threaded bolt member [24] is held in position through the use of washer member [25], nut member [26], and split pin member [27]; an adjustable tripod mechanism to support devices/transducers for scientific measurements, wherein another locking bolt member [28], which can be inserted through any one of a multiplicity of circular perforations [29.1] to [29.n] drilled preferably, although not necessarily, perpendicularly on the female coupling members [13] and a similar number of preferably, and although not necessarily, matching circular perforations [30.1] to [30.n] drilled preferably, although not necessarily, perpendicularly on the male coupling members [14] (as clearly seen in FIG. 5) engage the said perforations together with washer members [31], nut members [32], and split-pin members [33] and thereby allowing selection of a desired angular extent to a given leg member relative to the tripod's major axis [47] (which is perpendicular to the plate member [10] and passing through its center); an adjustable tripod mechanism to support devices/transducers for scientific measurements, wherein the bolt member [28] allows immobilization of the respective leg member from a chosen angular extent relative to the tripod's major axis; an adjustable tripod mechanism to support devices/transducers for scientific measurements, wherein the tubular leg member segments [15] and [16] of each leg are provided with a multiplicity of diametrically opposed perforations [34] that are drilled radially on its circumferential surface, wherein the said perforations [34] are used to alter the effective length of a given leg of the tripod by joining the said tubular leg members [15] and [16] of each leg member through the use of a manually operable locking member means, which might preferably, although not necessarily, be bolt member means [35], washer member means [36] and [37], and nut member means [38]; an adjustable tripod mechanism to support devices/transducers for scientific measurements, wherein the last member [17] of each leg is coupled to a base plate member [18] through a joint mechanism consisting of a coupling member [48] integrally joined to the said base plate member [18], a matching coupling member [49] integrally joined to the leg member [17], a bolt member [50], washer member [51], and a nut member [39]; an adjustable tripod mechanism to support devices/transducers for scientific measurements, wherein the base member [18] is provided with an array of a multiplicity of perforations [40] to provide excellent grip between the floor and the tripod; an adjustable tripod mechanism to support devices/transducers for scientific measurements, wherein the said perforations [40] can also be used to drive rivets/nails/bolts into the terrain/floor if such an action is useful/necessary in a given deployment environment/site.

In an embodiment of the present invention, the legs of the tripod mechanism are capable of converging towards the major axis [47] of the tripod for storage and transport purposes and diverge away from the major axis [47] of the tripod to attain the maximum desirable base area and, therefore, stability during deployment.

In another embodiment of the present invention, a multiplicity of adjustable members allow erection of the tripod device in limited and/or confined areas or on uneven/multilevel surfaces such as open terrain, still permitting the platform of the mounted device to be in a desired plane.

In yet another embodiment of the present invention, the perforations [34] on the leg member segments [15] and [16] of each leg allow for choice of any intended longitudinal extent to the corresponding leg member of the tripod.

In a further embodiment of the present invention, the legs are independently adjustable and in telescoping tubular form thereby enabling easy adjustment of its length and leveling of its instrument/transducer mounting platform [10] in a given plane.

In another embodiment of the present invention, each independently adjustable leg member can be selectively positioned thereby enabling easy adjustment of its length and leveling of its instrument/transducer mounting platform in a given plane even on an uneven terrain.

In yet another embodiment of the present invention, the telescopically adjustable support leg members can have both pivotal and slidable adjustments to set a desired height as well as the perimeter/base area of the tripod, thereby allowing for multiple angularities and configurations.

In a further embodiment of the present invention, a plurality of transverse perforations [34] provided on the wall thickness of the hollow tubular leg members [15] and [16] allow the coaxially and longitudinally operating tubular leg segments to be locked by insertion of appropriate pins/bolts radially inward of the leg segments.

In a still further embodiment of the present invention, the telescoping outer and inner tubular members of each leg members of the tripod are longitudinally extensible relative to each other, and are aligned substantially parallel to each other so that the said inner tubular member can slide freely until the fastening/locking means [35] are inserted in position through the chosen perforations [34].

In yet another embodiment of the present invention, the locking/fastening means [35] can be conveniently and releaseably positioned at different locations along the telescoping outer tubular member and the inner tubular member of the legs of the tripod to secure the said telescopic tubular members without reducing/degrading the stability and structural integrity of the tripod.

In another embodiment of the present invention, removal of bolt members [28] from the perforation [29] and [30] of a given leg member permits collapsing of that leg member towards the major axis [47] of the tripod, thereby permitting space saving during disassembly and packing prior to transportation to a remote location.

In a further embodiment of the present invention, the perforation means [34] on the telescopic leg members [15] and [16] of the tripod provides strength and rigidity at a reduced weight, simultaneously providing a means for locking two adjacent segments of the tripod.

In a still further embodiment of the present invention, the tilt angles or spacing of the legs from the major axis [47] of the tripod can be selected to be identical or non-identical in order to cater to an even or uneven terrain respectively while maintaining the instrument/transducer mounting platform in a desired plane.

In another embodiment of the present invention, the tubular member [41], which is integrally joined to the planar plate member [10], has an integral step in the form of an exterior collar [42] so that the separation between the plate members [10] and [11] can remain flexible to a certain distance to allow fine tuning of the height of the plate member [10] by manually turning the nut member [46], which is integrally joined to the bolt member [12].

In yet another embodiment of the present invention, the tubular member [41] extends downward through a central axial perforation drilled perpendicularly on the planar surface of the plate member [11] so that the planar plate member [10] together with the mounted device/transducer can be rotated in any desired azimuthal direction without having to rotate the entire tripod.

In still another embodiment of the present invention, the tubular member [41] can be fixed in any desired position with the use of a washer member [43], nut member [44] and locked in position with the use of a lock-nut member [45], thereby enabling the mounted device/transducer to be rigidly fixed in any desired azimuthal orientation.

In another embodiment of the present invention, a simple mechanism consisting of members [13], [14], [24], and [28] together with accessories provides a means for selection of the desired angular extent of each leg in relation to the major axis [47] of the tripod and to lock the tripod leg assemblies together in the desired relationships, thereby inhibiting the use of the conventionally used spikes/rods to stabilize the tripod legs on the floor.

In a further embodiment of the present invention, the planar base plate members [18] pivotably attached to the lower end of each leg embracingly couples to the terrain to which it comes into physical contact thereby preventing the legs from piercing into a soft terrain and this provides increased versatility and stability to the tripod even on an uneven and soft terrain.

In yet another embodiment of the present invention, the tripod mechanism facilitates quick assembly and de-assembly, which is an issue of paramount importance in periodic survey operations in numerous remote areas.

In a further embodiment of the present invention, the top portion of the member [17] of each leg is a threaded member to allow fine-tuning the length of the respective leg.

In a still further embodiment of the present invention, a spirit level [19] that is rigidly mounted on the top planar surface portion of plate member [10] permits correct trimming/leveling of the mounted device to a horizontal plane with the judicious use of the nut members [46].

In another embodiment of the present invention, the cylindrical shape imparted to the leg member segments of the tripod facilitates trouble-free handling of the support mechanism during assembly, de-assembly, and packing.

In yet another embodiment of the present invention, the washer means [25], [31], [36], and [37] might preferably—although not necessarily—be rubber pad means to provide flexibility, grip, and efficient stiffening property.

In still another embodiment of the present invention, the edges of all the members are chamfered/rounded to enhance safety of handling and ease of operation.

In a still further embodiment of the present invention, the entire device is easy to be assembled and mounted, and is amenable to quick changes of angles and heights, thereby serving as a time saver during deployments/de-deployments.

In another embodiment of the present invention, the joint consisting of members [48], [49], [50], [51], and [39] may be replaced by a ball-and-socket arrangement to provide enhanced versatility for turning of the plate member [18] in all possible directions.

In yet another embodiment of the present invention, all the members of the device are coated with a suitable protective material to allow its use in any environment.

### BRIEF DESCRIPTION OF THE ACCOMPANYING DRAWINGS

In the drawings accompanying this specification:

FIG. 1 represents a system of the prior art used for mounting a meteorological instrument used for measurement of meteorological parameters such as wind speed and direction, barometric pressure, solar radiation, air temperature, humidity and the like.

FIG. 2 shows the isometric view of the adjustable tripod mechanism to support devices/transducers for scientific measurements of the present invention.

FIG. 3 is an expanded view of the top section of the adjustable tripod mechanism of FIG. 2.

FIG. 4 is the elevation view of the top section of the adjustable tripod mechanism of FIG. 2.

FIG. 5 is a partially cut out view of the top section of the adjustable tripod mechanism of FIG. 2.

FIG. 6 is a close up view of a segment of the joint between the outer and the inner tubular portion of a leg of the adjustable tripod mechanism of FIG. 2.

FIG. 7 is a close up view of the foot of a leg of adjustable tripod mechanism of FIG. 2.

FIG. 8 shows a typical example illustrating the usefulness of the of the adjustable tripod mechanism of FIG. 2, wherein the wind pattern at the three corners of the Gulf of Kachchh, India, obtained based on measurements made with the support of the mounting mechanism of the present invention is shown.

### DETAILED DESCRIPTION OF THE INVENTION

The invention will now be described in detail with reference to the accompanying drawings.

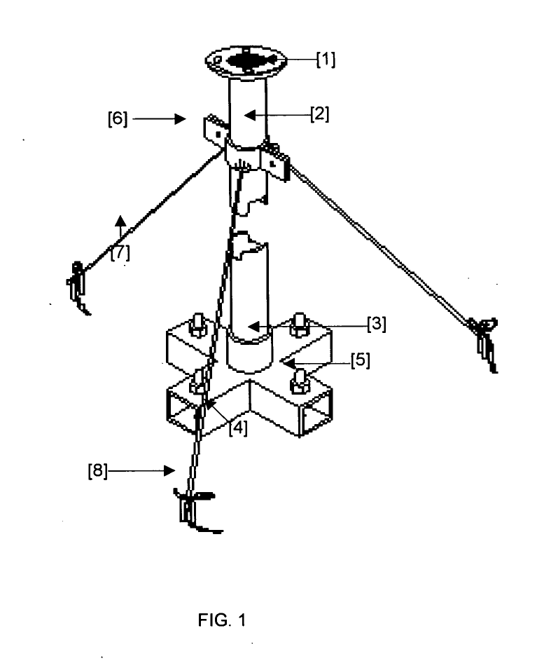

FIG. 1 represents a typical design example, showing a support mechanism of the prior art used by R. G. Prabhu Desai, P. Mehra, E. Desa, S. Nagvekar, and V. Kumar in “Weather Station for Scientific Data Collection”, Second Indian National Conference on Harbour and Ocean Engineering (Inchoe-97), pp. 688-697 (1997). This mechanism consists primarily of a mounting platform [1] for holding the instrument, transducer, and the like, attached to a support staff [2] wherein this mounting platform is securable to the housing of the instrument, transducer, and the like. The support staff [2] is inserted into the collar [3] that is integrally attached to a cross-shaped base structure [4]. This base structure can be rigidly attached to the floor with the use of four bolt-and-nut arrangements [5]. The support staff [2] is further reinforced against the impact of wind force by the use of three guy wires [7] attached between a pair of collar sleeves [6] and three U-pins [8] driven into the floor and further reinforced by concrete. A limitation of the support mechanism of FIG. 1 is that it requires purpose-built structures for its erection and, further, it does not facilitate quick assembly and de-assembly, which is an issue of paramount importance in periodic survey operations in remote areas.

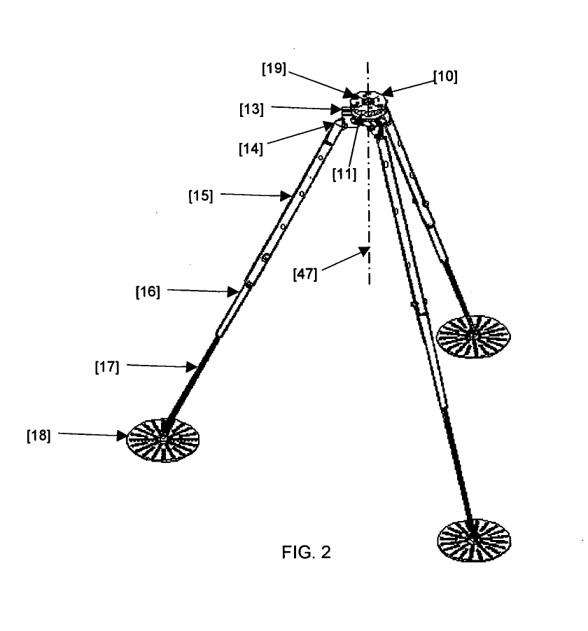

FIG. 2 shows the isometric view of the adjustable tripod mechanism to support devices/transducers for scientific measurements of the present invention, which consists primarily of a planar plate member [10] for mounting any device such as an instrument, transducer, and the like; another planar plate member [11] attached to the planar plate member [10] wherein the said planar plate member [11] is integrally joined to at least three pairs of female coupling members [13] to each of which a male coupling members [14] are loosely joined. The male coupling members [14] are integrally joined to tubular members [15], which are further loosely and telescopically attached to inner tubular members [16]. The member [16] is attached to another tubular member [17], whose bottom end is pivotably coupled to base plate member [18]. A spirit level [19] is integrally joined to the top planar plate member [10] for the purpose of leveling the said plate member [10] to a horizontal plane.

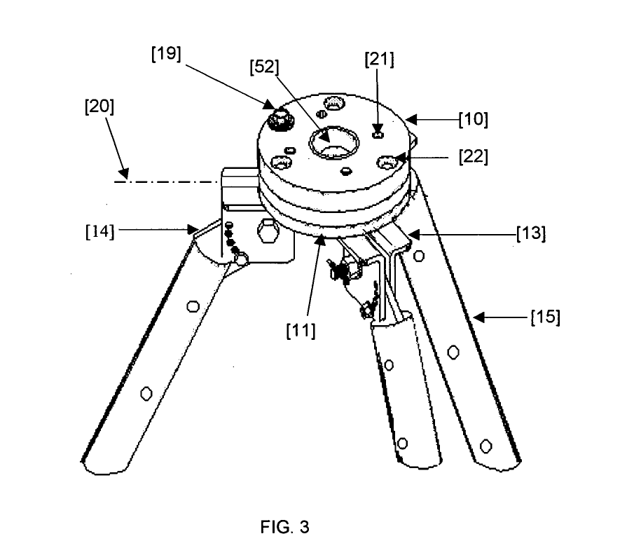

FIG. 3 is an expanded view of the top section of the adjustable tripod mechanism of FIG. 2. The planar plate member [11] is integrally joined to at least three pairs of female coupling members [13] to which male coupling members [14] are loosely joined. The male coupling members [14] are integrally joined to the top members [15] of at least three legs. Each of these legs is adapted to pivot in radial planes along the planar slot [20] provided on the female coupling member [13]. The legs of the tripod mechanism are thus capable of converging towards the major axis [47] of the tripod for storage and transport purposes and diverge away from the major axis of the tripod to attain the maximum base area and, therefore, stability during deployment. Slots [21] provided on the top planar plate member [10] enables mounting of devices, transducers, transceivers and the like.

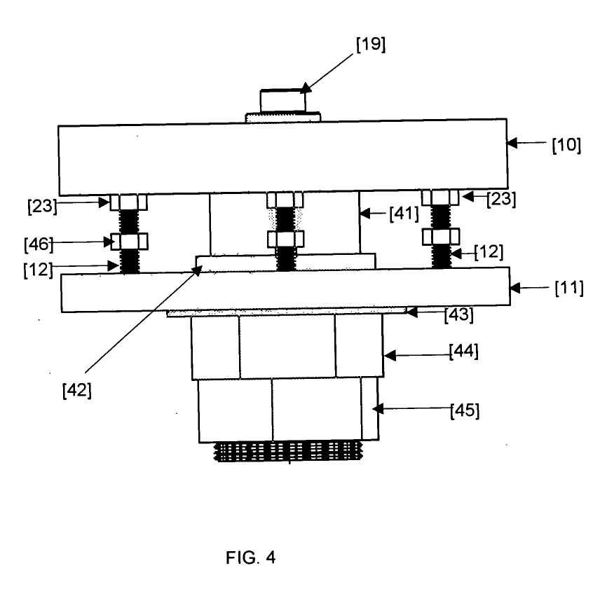

FIG. 4 is the elevation view of the top section of the adjustable tripod mechanism of FIG. 2. The planar plate member [11] is attached to the planar plate member [10] with the use of the tubular member [41], which is integrally joined to the planar plate member [10]. Three equally spaced threaded support members [12] are positioned in notches [22] drilled on the upper planar surface of the circular plate member [10]. The bottom portions of the support members [12] rest on the top surface of the planar plate member [11]. These support members cooperate with the interior surface of the nut members [23] to ensure their guiding in rotation thereby facilitating trouble-free upward/downward motion of the top planar plate member [10] through the desired spatial separation relative to the planar plate member [11]. The tubular member [41] has an integral step in the form of an exterior collar [42] so that the separation between the plate members [10] and [11] can remain flexible to a certain distance to allow fine tuning of the height of the plate member [10] by manually turning the nut member [46], which is integrally joined to the bolt member [12]. The said tubular member [41] extends downward through a central axial perforation drilled perpendicularly on the planar surface of the plate member [11] so that the planar plate member [10] together with the mounted device/transducer can be rotated in any desired azimuthal direction. The tubular member [41] can be fixed in any desired position with the use of a washer member [43], nut member [44] and locked in position with the use of a lock-nut member [45], thereby enabling the mounted device/transducer to be rigidly fixed in any desired azimuthal orientation. The tubular member [41] extends downward through a central axial perforation drilled perpendicularly on the planar surface of the plate member [11] so that the planar plate member [10] together with the mounted device/transducer can be rotated in any desired azimuthal direction without having to rotate the entire tripod. The tubular member [41] can be fixed in any desired position with the use of a washer member [43], nut member [44] and locked in position with the use of a lock-nut member [45], thereby enabling the mounted device/transducer to be rigidly fixed in any desired azimuthal orientation.

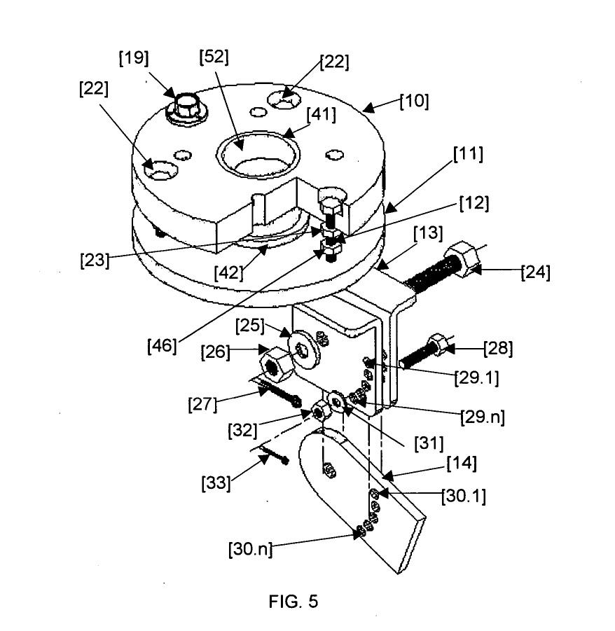

FIG. 5 is a partially cut out view of the top section of the adjustable tripod mechanism of FIG. 2, demonstrating detailed constructional features, particularly the support member [12], its nut members [23] and [46], the female coupling members [13], and its male coupling members [14]. Each pair of these coupling members is pivotably coupled to each other through a threaded bolt member [24] so that the corresponding leg members [15], [16], [17] together with the base plate member [18] are free to swing about the bolt member [24]. Thus, the bolt member [24] operates as a hinge mechanism that allows folding the respective leg member along the axial plane of the female coupling member of each leg, thereby enabling the pivoting of the legs to be controlled. The threaded bolt member [24] is held in position through the use of washer member [25], nut member [26], and split pin member [27]. Another locking bolt member [28], which can be inserted through any one of a multiplicity of circular perforations [29.1] to [29.n] drilled perpendicularly on the female coupling members [13] and a similar number of circular perforations [30.1] to [30.n] drilled perpendicularly on the male coupling members [14] engage these perforations together with washer members [31], nut members [32], and split-pin members [33]. This arrangement allows selection of a desired angular extent to a given leg member relative to the tripod's major axis [47] (which runs perpendicular to the plate member [10] and passes through its center). The bolt member [28] allows immobilization of the respective leg member from a chosen angular extent relative to the tripod's major axis.

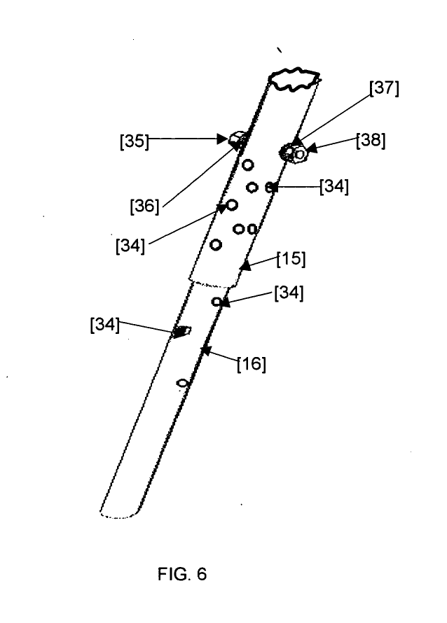

FIG. 6 is a close up view of a partial segment of the joint between the outer and the inner tubular portions of a leg of the adjustable tripod mechanism of FIG. 2, wherein the tubular members [15] and [16] of each leg are provided with a multiplicity of diametrically opposed perforations [34] drilled radially on its circumference. These perforations are used to alter the length of a given leg by joining the tubular members through the use of a manually operable locking means, which might preferably, although not necessarily, be bolt means [35], washer means [36] and [37], and nut means [38]. The perforations on the leg segments allow for choice of any intended longitudinal extent to the legs of the tripod.

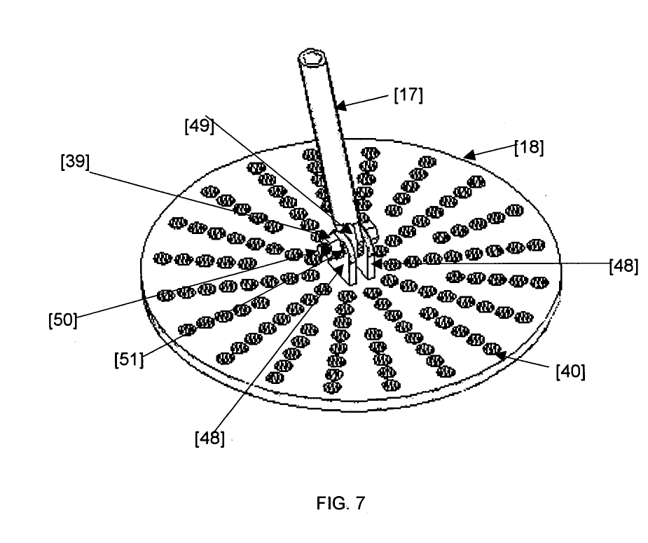

FIG. 7 is a close up view of the foot of a leg of the adjustable tripod mechanism of FIG. 2. The last tubular member [17] of each leg is coupled to a base member [18] through a joint consisting of a female coupling member [48] which is integrally joined to the base member [18], a male coupling member [49] which is integrally joined to the leg member [17], a bolt member [50], washer member [51], and a nut member [39]. The base member [18] is provided with an array of a multiplicity of perforations [40] to provide sufficient grip between the floor and the tripod. The said perforations [40] can also be used to drive nails/rivets into the floor if such an action is useful/necessary in a given deployment site/environment.

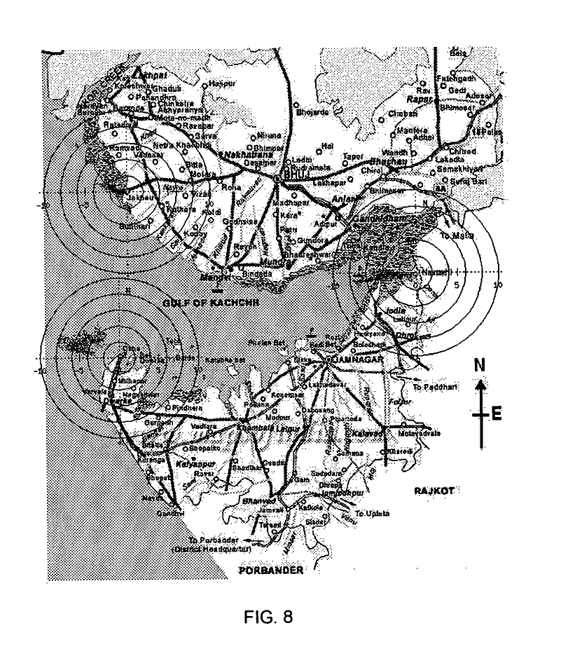

FIG. 8 shows a typical example illustrating the usefulness of the adjustable tripod mechanism of FIG. 2, wherein the wind pattern at the three corners of the Gulf of Kachchh, India, obtained based on measurements made with the support of the mounting mechanism of the present invention is shown.

The above-mentioned are illustrative of the invention and are not to be construed as limiting the scope of the invention in any manner. An adjustable tripod mechanism to support devices/transducers for scientific measurements of the present invention may be practiced in many other forms and in combination with other devices/members. Many changes could be made in the use of this invention as necessary to serve a particular application without departing from the spirit and scope of this invention. Therefore, these figures are not to be construed as limiting in any manner.

### THE MAIN ADVANTAGES OF THE PRESENT INVENTION ARE

1. It provides a simple mechanical support device having independently adjustable telescoping tubular legs, thereby enabling easy adjustment of its height and leveling of its instrument/transducer mounting platform in a given plane.
2. It provides a simple tripod device having the capability of rotation of the mounted device/transducer in any desired azimuthal direction without having to rotate the entire tripod.
3. It provides a simple tripod device, which allows fine-tuning of the height and the level plane of the mounted device/transducer by manually turning a few nut members.
4. It provides a simple tripod device whose legs are adjustable over a range of lengths, or spread outwards to provide a large base area during deployment in its supporting position.
5. It provides a simple mechanical support device having telescopically movable outer and inner tubular leg members thereby allowing their independent movement for selective independent positioning of the support device.
6. It provides a simple tripod device whose legs can be selectively positioned thereby enabling easy adjustment of its height and leveling of its instrument/transducer mounting platform in the horizontal plane.
7. It provides a simple tripod device having the capability of rigidly fixing the mounted device/transducer in any desired azimuthal orientation.
8. It provides a simple tripod device in which the tip of each of its legs may be stabilized against sinking into the floor during deployment in a rather loose terrain.
9. It provides a simple tripod device whose legs are collapsible, wherein each of the telescopic leg may be shrunk along its axis to reduce its length and folded inward toward its central axis to reduce the base area to a minimum during storage, transportation, or/and in its carrying position.
10. It provides a simple tripod device wherein the tilt angles or spacings of the legs from its central axis can be selected to be identical or non-identical in order to cater to an even or uneven terrain respectively while maintaining the instrument/transducer mounting base in a horizontal plane.
11. It provides a measuring instrument/transducer supporting mechanism that is capable of easy assembly and mounting, thereby serving as a time saver during erection in a remote environment.
12. It provides a simple tripod device, for supporting instruments/transducers, which is free from complicated and cumbersome mechanical members.
13. It provides a simple tripod device, for supporting instruments/transducers, which is sturdy and can be economically constructed from any suitable materials by conventional fabrication methods.
14. It provides a simple tripod device, for supporting instruments/transducers, which does not require the use of cumbersome electrical devices such as motors.

1. An adjustable tripod mechanism to support devices/transducers for scientific measurement, comprising primarily of a first planar plate member for mounting device such as an instrument, transducer, and the like; a second planar plate member attached to the first planar plate member, the second planar plate member being integrally joined to at least three pairs of female coupling members, each female coupling member being in turn connected loosely to a respective mating coupling member.

2. An adjustable tripod mechanism as claimed in claim 1, wherein the mating coupling members are integrally connected to tubular leg members, which are further loosely and telescopically connected to inner tubular leg members, each of the inner tubular leg members being attached to a further respective tubular leg member, the bottom end of the further respective tubular leg member being pivotably coupled to a base plate member.

3. An adjustable tripod mechanism as claimed in claim 1, wherein a spirit level is integrally connected to the first planar plate member at the top end thereof for leveling the first planar plate member to a horizontal plane.

4. An adjustable tripod mechanism as claimed in claim 2, wherein each of leg members comprising of leg segment member and base plate member are adapted to pivot in radial planes along a planar slot provided on a respective female coupling member.

5. An adjustable tripod mechanism as claimed in claim 1, wherein the first planar plate member is provided with slots at the top thereof to enable mounting of scientific instruments such as transducers and transceivers.

6. An adjustable tripod mechanism as claimed in claim 1, wherein the second planar plate member is attached to the first planar plate member through a tubular member which is integrally joined to the first planar plate member.

7. An adjustable tripod mechanism as claimed in claim 1, wherein the first planar plate member is provided with notches drilled on the upper planar surface thereof and wherein respective threaded support members are positioned in the notches.

8. An adjustable tripod mechanism as claimed in claim 7, wherein the bottom portion of the support members rests freely on the second planar plate member and cooperate with an interior surface of nut members to ensure the guiding of the support members in rotation thereby facilitating trouble-free upward/downward movement of the first planar plate member through a desired spatial separation relative to the second planar plate member.

9. An adjustable tripod mechanism as claimed in claim 1, wherein a tubular member, which is integrally joined to the first planar plate member, has an integral step in the form of an exterior collar to ensure flexibility in the separation between the plate members to a certain distance to allow fine tuning of the height of the first plate member by manually turning a nut member, which is integrally joined to the bolt member.

10. An adjustable tripod mechanism as claimed in claim 9, wherein the tubular member extends downward through a central axial perforation provided drilled perpendicularly on a planar surface of the second plate member so that the first planar plate member together with the mounted device/transducer can be rotated in any desired azimuthal direction without having to rotate the entire tripod.

11. An adjustable tripod mechanism as claimed in claim 10, wherein subsequent to the rotation of the planar plate member for selection of the desired orientation, the tubular member is lockable in the chosen position with the use of a washer member, nut member and locked in position with the use of a lock-nut member, thereby enabling the mounted device/transducer to be rigidly fixed in any desired azimuthal orientation.

12. An adjustable tripod mechanism as claimed in claim 1, wherein each pair of the coupling members and its mating coupling members is pivotably coupled to each other through a threaded bolt member so that the corresponding leg segment members together with the base plate member are free to swing about the bolt member, the bolt member thereby operating as a hinge to allow folding the respective leg member along the axial plane of the coupling member of each leg, thereby further enabling the pivoting of the legs to be controlled.

13. An adjustable tripod mechanism as claimed in claim 12, wherein the threaded bolt member is held in position through the use of washer member, nut member, and split pin member.

14. An adjustable tripod mechanism as claimed in claim 1, wherein the female coupling member is provided with a plurality of circular perforations drilled perpendicularly thereon and wherein a locking bolt member is insertable therethrough, the male coupling members being provided with corresponding circular perforations drilled perpendicularly thereon to engage the perforations together with washer members, nut members, and split-pin members thereby allowing selection of a desired angular extent to a given leg member relative to the tripod's major axis which is perpendicular to the plate member and passing through its center.

15. An adjustable tripod mechanism as claimed in claim 14, wherein the bolt member is connected to the respective leg member to immobilize the respective leg member from a chosen angular extent relative to the tripod's major axis.

16. An adjustable tripod mechanism as claimed in claim 1, wherein the tubular leg member segments of each leg are provided with a plurality of diametrically opposed perforations drilled radially on the circumferential surface thereof, the length of a given leg member being alterable using the plurality perforations by joining the said tubular leg members of each leg member through the use of a manually operable locking member means consisting of bolt member means, washer member means, and nut member means.

17. An adjustable tripod mechanism as claimed in claim 1, wherein the last member of each leg is coupled to a base plate member through a joint mechanism consisting of a female coupling member that is integrally joined to the said base plate member, a matching male coupling member that is integrally joined to the leg member, a bolt members, washer member and a nut member.

18. An adjustable tripod mechanism as claimed in claim 17, wherein the base member is provided with an array of a multiplicity of perforations to provide a grip between the tripod and a floor.

19. An adjustable tripod mechanism as claimed in claim 18, wherein the perforations are adjustable to hold securing means selected from the group consisting of rivets, nails and bolts.

20. An adjustable tripod mechanism as claimed in claim 1, wherein the legs of the tripod mechanism are adaptable to converge towards a major axis of the tripod for storage and transport purposes and diverge away from the said major axis of the tripod to attain the maximum desirable base area and, therefore, stability during deployment.

21. An adjustable tripod mechanism as claimed in claim 1, wherein the legs are independently adjustable and in telescoping tubular form thereby enabling easy adjustment of its length and leveling of its instrument/transducer mounting plate in a given plane.

22. An adjustable tripod mechanism as claimed in claim 1, wherein the telescopically adjustable support leg members can have both pivotal and slidable adjustments means to set a desirable height as well as the perimeter/base area of the tripod, thereby allowing for multiple angularities and configurations.

23. An adjustable tripod mechanism as claimed in claim 1, wherein a plurality of transverse perforations are provided on the wall thickness of the hollow tubular leg members to allow the coaxially and longitudinally operating tubular leg segments to be locked by insertion of appropriate pins/bolts radially inward of the leg segments.

24. An adjustable tripod mechanism as claimed in claim 23, wherein the telescoping outer and inner tubular members of each leg members of the tripod are longitudinally extensible relative to each other, and are aligned substantially parallel to each other so that the said inner tubular member can slide freely until fastening/locking means are inserted in position through the chosen perforations.

25. An adjustable tripod mechanism as claimed in claim 1, wherein the top end of the member of each leg is a threaded member to allow fine-tuning the length of the respective leg.

26. An adjustable tripod mechanism as claimed in claim 1, wherein a spirit level is rigidly mounted on the top planar surface portion of plate member to permit or correction or trimming or leveling of the device mounted on the tripod to a horizontal plane through the nut members.

27. An adjustable tripod mechanism as claimed in claim 1, wherein the edges of all the members are chamfered or rounded to enhance safety of handling and ease of operation.

28. An adjustable tripod mechanism as claimed in claim 1 wherein the joint members comprise a ball-and-socket device to provide enhanced versatility for turning of the plate members in all possible directions.

29. An adjustable tripod mechanism as claimed in claim 1, wherein perforation are provided on the planar plate members passing therethrough to provide guide means.
